(19) United States
(12) Patent Application Publication
(10) Pub. No.: US 2012/0263487 A1
(43) Pub. Date: Oct. 18, 2012

(54) FIXING DEVICE, IMAGE FORMING APPARATUS USING THE SAME AND CONTROLLING MEHOD OF THE SAME

(75) Inventor: Satoshi ITAYA, Shizuoka-ken (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/446,136

(22) Filed: Apr. 13, 2012

Related U.S. Application Data
(60) Provisional application No. 61/476,579, filed on Apr. 18, 2011.

(51) Int. Cl. G03G 15/20

(52) U.S. Cl. 399/68

(57) ABSTRACT

The fixing device according to the embodiment includes a fixing member which is heated at predetermined temperature for a fixing, a press member which is configured to move relative to the fixing member and to contact with the fixing member so as to transport an image bearing medium by cooperating with the fixing member during a fixing, driving member which moves the fixing member and press member in a plurality of speeds including predetermined speed for during the fixing, pressure change member which is configured to change a pressure between the fixing member and the press member, and control member which controls the driving member and the pressure change member, when the fixing member and the press member are idle for fixing, to reduce the pressure and the speed of the fixing member and the press member compared with during the fixing.

### CROSS-REFERENCE TO RELATED APPLICATIONS

This application is based upon and claims the benefit of priority from the U.S. Provisional Application No. 61/476,579, filed on Apr. 18, 2011, the entire contents of which are incorporated herein by reference.

### FIELD

Embodiments described herein relate generally to a fixing device used in an image forming apparatus.

### BACKGROUND

As a fixing device which is used in a dry-type copying machine, or the like, a device which includes a heating roller and a press roller, and in which the press roller is arranged by being pressed onto the heating roller side is widely used. There is a fixing device in which a heating belt is used instead of the heating roller, however, an example in which the heating roller is used will be described here. When the press roller is pressed onto the heating roller, the press roller with an elastic layer which is formed on the surface thereof is deformed, and a press contacting portion which is referred to as a fixing nip portion is formed between the press roller and the heating roller. Toner is fixed onto a sheet by being heated and pressed when the sheet carrying a toner image passes through the fixing nip portion.

In a copying machine, there is a toner replenishment mode in which toner is forcibly replenished by being interrupted in an image forming operation, or an image quality maintaining mode in which a toner pattern image is formed on an intermediate belt, or the like, and corrects image forming conditions by detecting a state of the toner pattern image, in addition to an operation of image forming by operating a fixing unit. In addition, there is a mode of controlling, as well, which is referred to as high temperature wait, or low temperature wait in which the fixing unit is in a stand-by state until the temperature returns to a certain range, when a temperature of the heating roller, or the press roller becomes abnormally high, or low.

In such a non-image forming state, it is not necessary to operate the fixing unit. However, in a copying machine in the related art, the heating roller and the press roller is rotated by being in contact with each other.

When both the rollers are rotated in a state where a sheet is not present, it causes a progress of abrasion on the surface of the roller, lowering of hardness, and a change in the outer diameter. In addition, there is a problem in that release characteristics of roller is deteriorated due to a filling material for paper (calcium carbonate) which is attached to the surface of the roller is buried on the surface of the roller.

With respect to such a problem, there is a technology in which the heating roller and the press roller are separated from each other while a fixing operation is not performed. However, a failure occurred when the heating roller and the press roller are separated, where a separation plate or the like which is in the vicinity of the fixing unit comes into contact with the heating roller, and scratches the surface of the fixing roller.

### DESCRIPTION OF THE DRAWINGS

FIG. 1 is a schematic configuration diagram which shows an image forming apparatus to which a fixing device according to an embodiment is mounted;

FIG. 2 is a cross-sectional view of the fixing device according to the embodiment;

FIG. 3 is a schematic configuration diagram of the fixing device according to the embodiment when seen from the top face;

FIG. 4 is a diagram which shows a driving gear train according to the embodiment;

FIG. 5 is a diagram which shows an electromagnetic clutch according to the embodiment;

FIGS. 6A and 6B are diagrams which show a contact state of a fixing roller and a press roller according to the embodiment;

FIG. 7 is a block diagram which shows a control unit of the fixing device according to the embodiment;

FIG. 8 is a diagram which shows a change in an operation state of the fixing device according to the embodiment; and

FIG. 9 is a flowchart which shows a transition operation from a fixing mode to a ready mode of the fixing device according to the embodiment.

### DETAILED DESCRIPTION

In general, according to one embodiment, it is to provide a fixing device including: a fixing member which is heated at predetermined temperature for a fixing; a press member which is configured to move relative to the fixing member and to contact with the fixing member so as to transport an image bearing medium by cooperating with the fixing member during a fixing; driving member which moves the fixing member and press member in a plurality of speeds including predetermined speed for during the fixing; pressure change member which is configured to change a pressure between the fixing member and the press member; and control member which controls the driving member and the pressure change member, when the fixing member and the press member are idle for fixing, to reduce the pressure and the speed of the fixing member and the press member compared with during the fixing.

Hereinafter, a fixing device, an image forming apparatus using the fixing device and a controlling method of the fixing device according to one embodiment will be described in detail with reference to accompanying drawings.

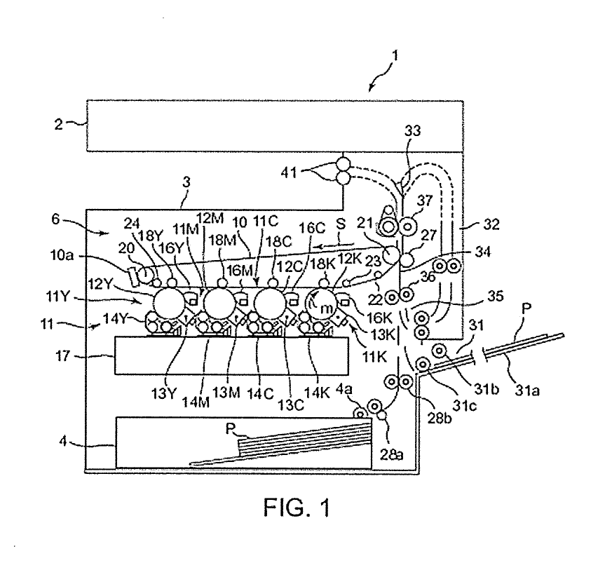

FIG. 1 is a schematic configuration diagram which shows an internal configuration example of an image forming apparatus 1 to which a fixing device 37 according to the embodiment is mounted. The image forming apparatus 1 is called in some cases MFP (Multi Function Peripherals).

The image forming apparatus 1 includes a scanner unit 2, a paper discharge unit 3, and an image forming portion 6. The scanner unit 2 is a unit which reads out an image on an original document as color image data (multi-valued image data), or monochrome image data (binary image data) by optically scanning the surface of the original document. The paper discharge unit 3 accommodates an image bearing medium P, for example, paper, on which an image is formed, and discharges the image bearing medium P from a housing of the device. The image forming portion 6 forms an image based on the color image data, or the monochrome image data on the image bearing medium P. The image forming portion 6 includes an image forming unit 11 which includes four sets of image forming stations 11Y, 11M, 11C, and 11K of yellow (Y), magenta (M), cyan (C), and black (K) which are arranged in parallel along the lower side of an intermediate transfer belt 10.

Each of the image forming stations 11Y, 11M, 11C, and 11K has the same configuration as each other, accordingly, the configuration and operation of the image forming station 11K for black will be described, and descriptions of other image forming stations will be omitted by being attached with corresponding reference numerals.

The image forming station 11K has a photoconductive drum 12K. A charger 13K, a developing unit 14K, and a photoconductor cleaning unit 16K are arranged along the rotation direction denoted by an arrow m at the periphery of the photoconductive drum 12K. Exposure light due to a laser exposure device 17 is radiated to the surface of the drum during which the drum reaches the developing unit 14K from the charger 13K of the photoconductive drum 12K. The exposure light is modulated according to the image signals and radiated, thereby, an electrostatic latent image is formed on the rotating photoconductive drum 12K.

The developing unit 14K includes a two-component developer which is formed, for example, of black (K) toner and a carrier. The developing unit 14K supplies the black toner to the electrostatic latent image on the photoconductive drum 12K.

Image forming portion 6 further includes an inter mediate transfer belt 10. The intermediate transfer belt 10 is stretched by a backup roller 21, a driven roller 20, and first to third tension rollers 22 to 24. The intermediate transfer belt 10 faces and contacts the photoconductive drums 12Y, 12M, 12C, and 12K. Primary transfer rollers 18Y, 18M, 18C, and 18K which perform a primary transfer of a toner image as an image which is formed on the photoconductive drums 12Y, 12M, 12C, and 12K to the intermediate transfer belt 10 are provided at positions of the intermediate transfer belt 10 which face the photoconductive drums 12Y, 12M, 12C, and 12K. Toner images of each color formed in each photoconductive drum are transferred onto the intermediate transfer belt 10 to be super imposed along with the movement thereof, by each of the primary transfer rollers, and are formed as a color image.

A secondary transfer roller 27 is arranged opposed to backup roller 21 via the intermediate transfer belt 10 in a secondary transfer portion of the intermediate transfer belt 10. In the secondary transfer portion, a secondary transfer bias is applied to the backup roller 21. A paper feeding cassette 4 for supplying the image bearing medium P to the secondary transfer roller 27 is provided at the lower part of the laser exposure device 17. A manual feed unit 31 which manually supplies the image bearing medium P is provided on the right side of the image forming apparatus 1.

A pickup roller 4a, a separation roller 28a, a transport roller 28b, and a resist roller 36 are provided between the paper feed cassette 4 and the secondary transfer roller 27 in order to transport the image bearing medium P from the paper feed cassette. A manual pickup roller 31b, a manual separation roller 31c are provided between a manual bypass tray 31a of the manual feed unit 31 and the resist roller 36 in order to transport the image bearing medium P on the manual bypass tray 31a.

The toner image on the intermediate transfer belt 10 is secondarily transferred during which the image bearing medium P is nipped and transported between the intermediate transfer belt 10 and the secondary transfer roller 27. After the secondary transfer, the intermediate transfer belt 10 on which untransferred toner is remaining is cleaned by the belt cleaner 10a. The fixing device 37 is provided on the downstream side of the secondary transfer roller 27 along the travelling direction of the image bearing medium P. The image bearing medium P which is fed from the paper feed cassette 4, or the manual feed unit 31 is transported to the fixing device 37 through the resist roller 36, and the secondary transfer roller 27 along a transport path 34. The toner image transferred on the image bearing medium P is fixed by the fixing device 37.

A gate 33 is provided on the downstream side of the fixing device 37, and is divided into a direction of a paper discharge roller 41, or a direction of a re-transport unit 32. The image bearing medium P which is guided by the paper discharge roller 41 is discharged to the paper discharge unit 3. The image bearing medium P which is guided by the re-transport unit 32 is, guided in a direction of the secondary transfer portion again.

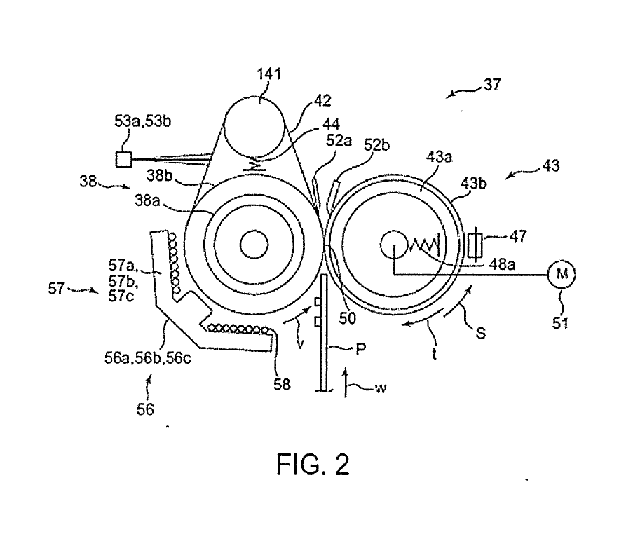

The fixing device 37 will be described with reference to FIGS. 2 to 6B. The fixing device 37 includes a fixing roller 38, a satellite roller 141, and an endless fixing belt 42 which is stretched between the fixing roller 38 and the satellite roller 141. In addition, a press roller 43 which comes into contact with the fixing roller 38 via the fixing belt 42 is further included. The fixing roller 38 and the fixing belt 42 make up fixing member. The press roller 43 configures a press member.

As an example of the fixing device 37, as shown in FIG. 2, the fixing roller 38 is formed by covering a foamed rubber (sponge) layer 38b of 8.5 mm thick as an elastic layer at the periphery of a cored bar 38a which is 2 mm thick. The outer diameter of the fixing roller 38 is 48.5 mm. The outer diameter of the satellite roller 141 is 17 mm. The satellite roller 141 is formed by, for example, coating the surface of a metal pipe which is made of, for example, aluminum. The satellite roller 141 is hard, and not easily deformed compared to the elastic layer of the fixing roller 38. A spring 44 which urges the satellite roller 141 in a direction which is distant from the fixing roller 38 is provided in the satellite roller 141, and due to the urging force, a constant tension is applied to the fixing belt 42.

The fixing belt 42 is formed by being sequentially laminated with a metal conductive layer formed of nickel which is, for example, 40 μm thick as a metal layer, a solid rubber layer of silicon rubber which is 200 μm thick, and a release layer of PFA (Polytetrafluoroethylene) tube of 30 μm thick. The fixing belt 42 has the outer diameter of approximately 60 mm when having a cylindrical shape, for example.

The fixing device 37 includes a coil 56, and a magnetic body 57 as a heating member of an electromagnetic induction type to be described later at the outer periphery of the fixing belt 42. The coil 56 is configured by a first coil 56a, a second coil 56b, and a third coil 56c.

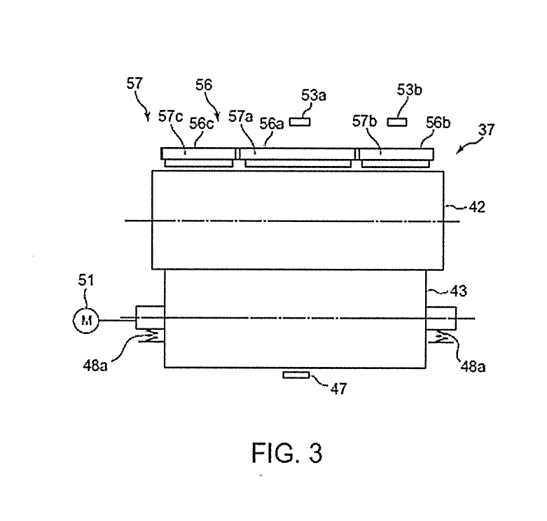

As shown in FIG. 3, the first coil 56a heats the center portion of the fixing belt 42 including the center in the width direction. The second and third coils 56b and 56c heat both sides of the fixing belt 42 not including the center in the width direction. The second and third coils 56b and 56c are connected to each other in series, and are driven under the same control. The first coil 56a or both the second coil 56b and the third coil 56c is selectively driven. The output of any of the coils can be adjusted, for example, from 200 W to 1500 W.

Each of coils 56a to 56c has each of magnetic cores 57a to 57c, and a conducting wire 58 wound therearound as shown in FIG. 2. As the conducting wire 58, for example, a litz wire bundle of 16 copper wires with a diameter of 0.5 mm which is covered with heat resistance polyamide-imide is used. When a high-frequency current is flown to the conducting wire 58, a magnetic flux is generated in each of coils 56a to 56c. Due to the magnetic flux, Joule heat is generated by the resistance of the metal conductive layer of the fixing belt 42, accordingly, the fixing belt 42 is instantly heated. The high-frequency current which is flown to each of the coils 56a to 56c is, for example, in a range of a frequency of 20 to 100 kHz.

As shown in FIG. 3, a first temperature sensor 53a which detects a temperature of the center portion of the fixing belt 42 which is heated as described above, and a second temperature sensor 53b which detects a temperature of side portions of the fixing belt 42 are arranged at the periphery of the fixing belt 42. As the first temperature sensor 53a and the second temperature sensor 53b, for example, a thermopile sensor which detects infrared light in a non-contact manner is used. The temperature of the fixing belt 42 in the width direction is controlled using the first temperature sensor 53a and the second temperature sensor 53b. The number of temperature sensors which detects the temperature of the fixing belt 42 is not limited to two. It is also possible to control temperature distribution of the fixing belt in the width direction, by measuring the center portion and both the side portions of the fixing belt 42 with three temperature sensors.

An example of the press roller 43 will be explained. Returning to FIG. 2, the press roller 43 has, for example, a rubber layer 43b at the periphery of the cored bar 43a. The outer diameter of the press roller 43 is, for example, 50 mm. As the rubber layer, for example, silicon rubber, or fluororubber is used. The press roller 43 has a roller temperature sensor 47 at the periphery thereof. The press roller 43 moves relative to the fixing the belt 42 and comes into contact with the fixing belt 42 by being pressed. Due to the contact of the press roller 43 by being pressed, a nip portion 50 is formed between the fixing belt 42 and the press roller 43. By providing a heating device such as an electromagnetic induction heater, or a halogen lamp in the press roller 43, as well, it is also possible to attempt further speed-up of FCOT (First Copy Output Time). A nip pressure as a pressure of the press roller 43 with respect to the fixing roller 38 can be adjusted. A nip pressure adjusting mechanism will be described later.

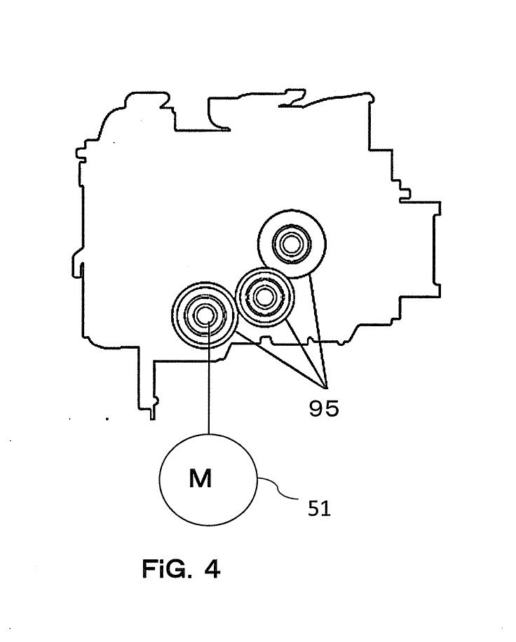

As shown in FIG. 4, the fixing device 37 includes a motor 51, and a driving gear train 95 which transmits a rotation of the motor 51 to the fixing roller 38 and the press roller 43 and the satellite roller 141 as a driving force. In addition, FIG. 3 is a cross-sectional view of the fixing device when seen from a front side of the image forming apparatus 1, however, FIG. 4 shows the driving gear train 95 which is seen from the rear side of the image forming apparatus 1. Due to the rotation of the driving motor 51, the fixing roller 38 rotates in the direction of v, or the press roller 43 rotates in the direction of an arrow t as shown in FIG. 2. The driving motor 51 is configured such that the rotation speed can be changed. In other words, the driving motor moves the fixing roller 38 and press roller in a plurality speeds.

A separation unit 52a which separates the medium P on which a toner image is fixed from the fixing belt 42, and a separation unit 52b which separates the medium P from the press roller 43 are provided on the downstream side of the nip portion 50 in the movement direction of the fixing roller 38 and the press roller 43 as shown in FIG. 2. A minute gap of approximately 0.3 mm to 0.5 mm is present between the fixing belt 42 and the separation unit 52a.

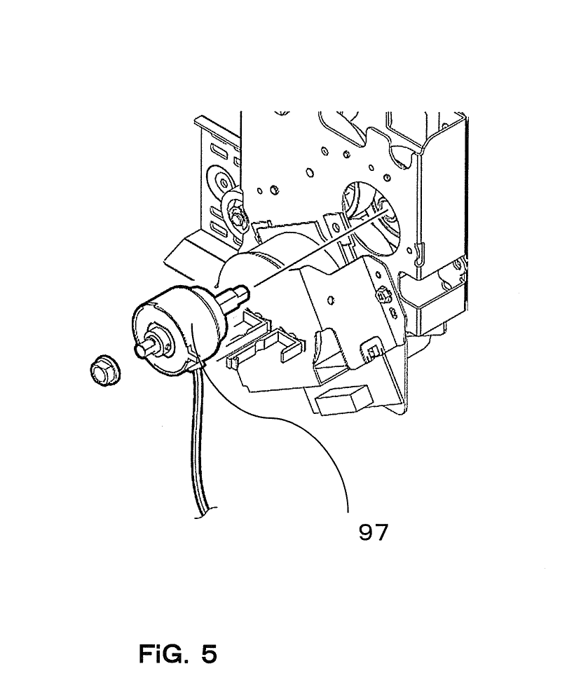

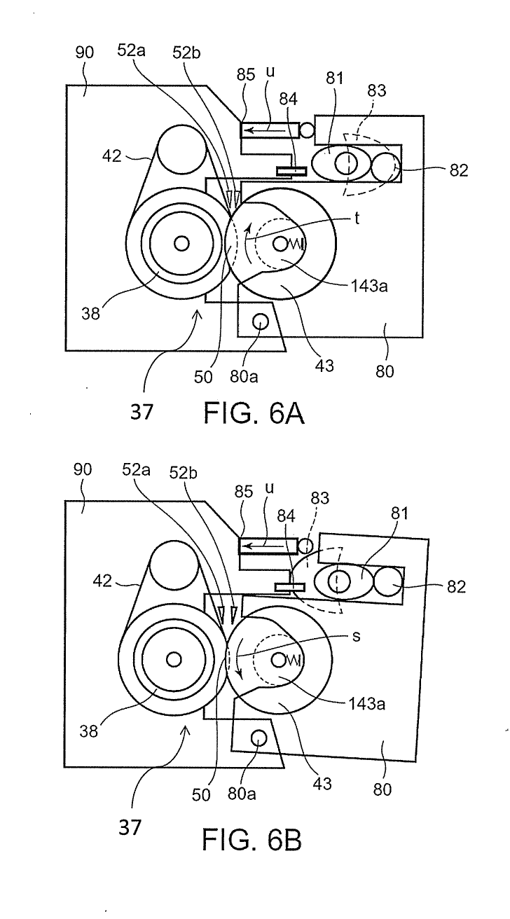

Subsequently, a specific configuration of a mechanism which adjusts an applied pressure of the press roller 43 with respect to the fixing roller 38 will be described with reference to FIG. 5, FIGS. 6A and 6B. FIG. 6A is a diagram which shows a state where a pressure of the nip portion 50 is high, and FIG. 6B is a diagram which shows a state where the pressure of the nip portion 50 is low.

As shown in FIGS. 6A and 6B, the fixing device 37 includes a press roller frame 80 to which the press roller 43 is mounted, a cam 81, a cam follower 82, a sensor 84, a pressure spring 85, and a fixing roller frame 90 as a pressure change mechanism.

Driving of a reverse rotation of the motor 50 is transmitted to the cam 81 by an electromagnetic clutch gear 97 shown in FIG. 5. Due to the rotation of the cam 81, it becomes a semi-separation state between the fixing belt 42 and the press roller 43 for a certain period.

The fixing roller frame 90 supports the fixing roller 38 to be rotatable. The fixing roller frame 90 supports a fulcrum 80a. In addition, the fixing roller frame 90 supports the sensor 84.

The press roller frame 80 rotationally moves with respect to the fixing roller frame 90 about the fulcrum 80a. A press roller axis 143a is supported by the press roller frame 80. When the press roller frame 80 rotationally moves about the fulcrum 80a, the press roller 43 also rotationally moves with respect to the fixing roller frame 90 along with the press roller axis 143a. The cam 81 is an elliptic type, and is able to eccentrically rotate by being pivotally supported. Since the cam 81 is eccentric, there are two cam surfaces of a surface which is far from the center of rotation, and a surface which is near from the center of rotation. When the surface of the cam near from the center of rotation of the cam 81 comes into contact with the cam follower 82, the nip pressure becomes high.

When a current flows to the electromagnetic clutch gear 97, and a reverse rotational force of the motor 50 is transmitted to the cam 81, the cam 81 rotates, and the cam surface which is far from the center of rotation of the cam 81 comes into contact with the cam follower 82. As a result, the press roller frame 80 rotationally moves in a direction which is separated from the fixing roller 38, and the nip pressure is lowered. This is not a state in which the fixing roller 38 and the press roller 43 are completely separated, but the semi-separation state in which a load between the press roller 43 and the fixing belt 42 becomes approximately a half of the road during a fixing mode and a warm-up mode to be described later. An abutting force in the semi-separation state is a less than half of load at the time of fixing, and is preferable to less than one third of the pressure during the fixing. According to the embodiment, the nip width of the nip portion 50 is 15 mm, and the nip at the time of separation is 4.5 mm.

In this manner, the fixing roller 38 and the press roller 43 are in the semi-separation state in order to prevent the fixing belt 42, or the press roller 43 from wearing down due to the rotation in a pressurized state other than the fixing time and warm-up time, and to ensure the life and quality of the fixing belt 42 or the like as consumables until the periodic replacement time.

On the other hand, the fixing roller and the press roller are not in the completely separated state, since the gap between the separation unit 52a and the fixing belt 42 becomes small at the time of separation, accordingly, there is a concern that the belt 42 is scratched by being rubbed, and an abnormal sound occurs when returning to the abutting state from the separated state.

The center distance between the fixing roller 38 and the press roller 43 is, for example, a distance in which the rotation center of the fixing roller 38 and the rotation center of the press roller 43 is connected. The diameter of the fixing roller 38 is set to φ30 mm, and the diameter of the press roller 43 is set to φ30 mm, for example, the center distance when the nip pressure is low is 29 mm, and is approximately 27 to 28 mm when the nip pressure is high.

The cam 81 is provided with a shutter 83 of a fan-like shape on the same axis. The fixing device 37 is provided with a sensor 84 for detecting contact and separation of the press roller. The sensor for detecting contact and separation of the press roller is a photo sensor, and an output of the photo sensor is changed when a position of the shutter 83 is changed along with the rotation of the cam 81. Due to this, the state of contact, or separation of the press roller is detected.

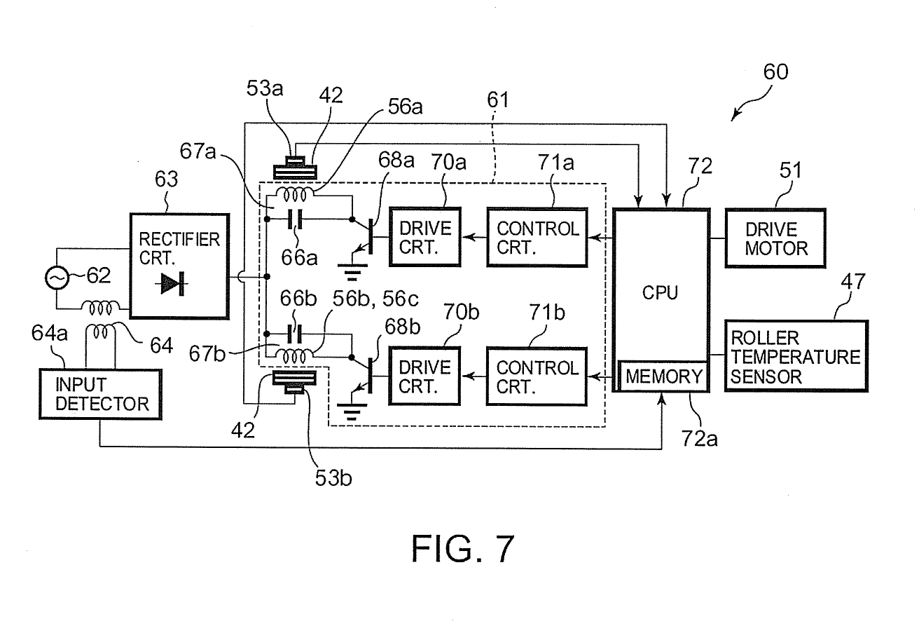

FIG. 7 shows a control device 60 of the fixing device 37. The control device 60 includes an inverter circuit 61 which controls a power supplied to each of coils 56a to 56c. The control device 60 includes a rectification circuit 63 which supplies a direct current in which a current from a commercial AC power supply 62 is smoothed to the inverter circuit 61. A transformer 64 is arranged in the previous stage of the rectification circuit 63, and it is possible to detect the total power dissipation through an input detection unit 64a.

The control device 60 includes a CPU 72 which controls the inverter circuit 61 according to a detection result of the first temperature sensor 53a and the second temperature sensor 53b. The CPU 72 controls a driving motor 51 according to a detection result of the first temperature sensor 53a and the roller temperature sensor 47. The power detected in the input detection unit 64a is fed back to the CPU 72.

The CPU 72 executes a variety of functions by performing a program which is stored in a memory 72a as a control unit, and performs various processing of the image forming apparatus 1 including the fixing device 37 or the like. In addition, the CPU 72 performs a current control with respect to the electromagnetic clutch gear 97 so that the pressure of the press roller 43 to the heating roller 37 is changed according to a mode of the fixing device 37. The memory 72a is, for example, a RAM (Random Access Memory), a ROM (Read Only Memory), a DRAM (Dynamic Random Access Memory), SRAM (Static Random Access Memory), VRAM (Video RAN), or the like, and takes a role of storing various information and programs which are used in the image forming apparatus 1. The memory 72a stores a table for setting a temperature, or a speed of the fixing device 37.

In the inverter circuit 61, a first capacitor 66a for resonance is connected to the first coil 56a in parallel, a first resonance circuit 67a is formed, and a second resonance circuit 67b is formed by being connecting a second capacitor 66b for resonance to the second coil 56b and the third coil 56c in parallel. In the inverter circuit 61, a first switching element 68a is connected to the first resonance circuit 67a, and similarly, a second switching element 68b is connected to the second resonance circuit 67b.

A first driving circuit 70a and a second driving circuit 70b are respectively connected to control terminals of the first switching element 68a and the second switching element 68b. These first and second driving circuits 70a and 70b are respectively connected to the CPU 72 through first and second control circuits 71a and 71b. The first and second control circuits 71a and 71b are instructed by the CPU 72, and respectively control ON time of the first and second switching elements 68a and 68b through the first driving circuit 70a and the second driving circuit 70b. By controlling ON time of the first and second switching elements 68a and 68b, it is possible to change the output value by changing the frequency in a range of 20 to 100 kHz.

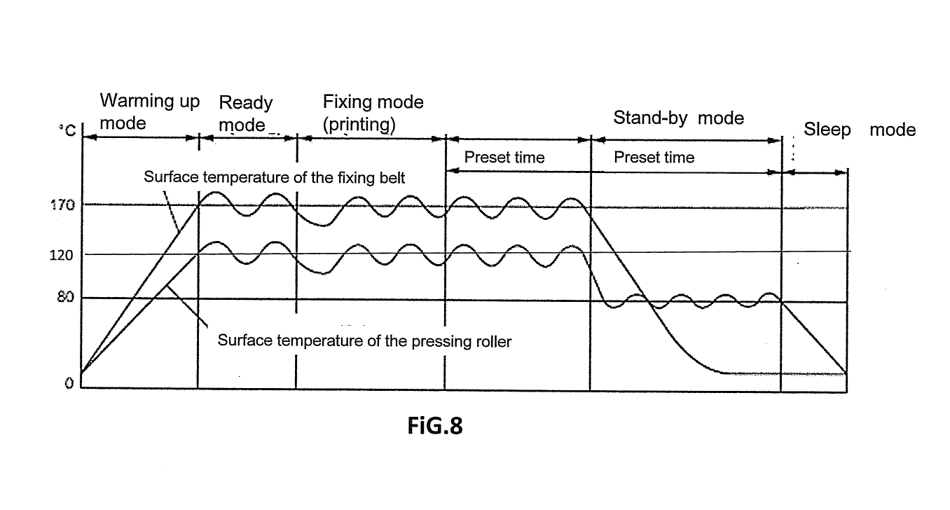

Subsequently, control processing of the fixing device 37 will be described. The power is turned on, the image forming apparatus 1 is started up, and then the control processing of the fixing device 37 is started. As shown in FIG. 8, the control processing of the fixing device 37 is configured by a warm-up mode, a ready mode, a fixing mode, a stand-by mode, and an automatic sleep mode, or the like.

Here, the warm-up mode is a mode in which the surface temperature of the fixing belt 42 and the press roller 43 is raised to a certain temperature while driving the fixing roller 38, the fixing belt 42, and the press roller 43 to be rotated, in order to set the fixing device 37 in a ready state for the fixing.

In the ready mode, the temperature of the fixing belt 42 and the press roller 43 is maintained at certain temperature by performing on and off control of heating by the coil 56 and the magnetic body 57, until the fixing device in which the warm-up is completed receives a command of staring printing or copying.

For example, as shown in FIG. 8, the temperature of the fixing belt 42 is maintained to 170° C., and the temperature of the press roller 43 is maintained to 120° C. in the ready mode after the warm-up mode.

The fixing mode is a mode in which the fixing device 37 is performing fixing processing during printing. The temperature of the fixing belt 42 is maintained to 170° C., and the temperature of the press roller 43 is maintained to 120° C.

The stand-by mode is an energy-saving mode in which after the ready mode is continued for a certain period of time which is set in advance after completing the printing, the heat is controlled by performing the on and off control so that the temperature of the press roller becomes, for example, 80° C. after the certain period of time. On the other hand the heating of the fixing belt 42 stops in the stand-by mode.

The automatic sleep mode is a mode in which the energy saving is further attempted by turning off all the heat when there is not any operation performed for 30 minutes, for example, since the beginning of the stand-by mode.

According to the embodiment, in the warm-up mode and the fixing mode, as shown in FIG. 6A, the press roller 43 comes into contact with the fixing roller 38 with a predetermined pressure.

On the other hand, during the ready mode, the stand-by mode, and the automatic sleep mode other than the warm-up mode and the fixing mode, as shown in FIG. 6B, the fixing roller 38 and the press roller 43 are in the semi-separation state.

Further, in the forcible toner replenishment mode, the image quality maintaining mode, in a low temperature waiting mode, and in a high temperature waiting mode, the heating roller and the press roller are in the semi-separation state, as well.

The forcible toner replenishment mode is a mode in which, when it is detected by an automatic toner sensor (not shown) that a toner concentration level is lower than a certain threshold value, and it is difficult to continue image forming in any of the developing units 14Y, 14M, 14C, and 14K during the image forming operation, the image forming operation is interrupted, and the toner replenishment is performed from a toner hopper which is not shown with respect to a developing unit of which the toner concentration level is lowered.

The image quality maintaining mode is a mode in which a toner pattern is formed on the intermediate transfer belt 10, concentration of the pattern is detected, and image forming conditions are controlled to be fed back. The low temperature waiting mode is a mode in which, when the temperature of the fixing belt 42, or the press roller 43 falls below a certain threshold temperature, the image forming operation is interrupted until the temperature becomes a certain threshold temperature in order to prevent a low-temperature offset.

The high temperature waiting mode is a mode in which, when the temperature of the fixing belt 42, or the press roller 43 is higher than a certain threshold temperature, the image forming operation is interrupted until the temperature becomes a certain threshold temperature, or lower, in order to prevent a high-temperature offset.

When it is the ready mode before and after the fixing mode, the stand-by mode and the forcible toner replenishment mode, the image quality maintaining mode, the low temperature waiting mode, and the high temperature waiting mode, a processing speed of the fixing device 37, that is, a movement speed of the fixing belt 42 and the press roller 43 is reduced compared to the fixing time. The speed reducing is performed by the CPU 72 which controls the rotation of the motor 51, and is set to less than half of the processing speed during the fixing. It is preferable to be in a range of ⅓ to ½ of the speed of the fixing.

The reason why reducing the speed in this manner is that, when the movement of the fixing belt 42 is stopped, or the moving speed is rapidly lowered due to the low heat capacity of the fixing belt 42, a temperature of a portion which, is not heated is rapidly lowered, and it leads to a low-temperature offset phenomenon. In addition, even when the filling material for paper on the surface of the press roller 43 comes into contact by being pressed by an abutting force between the press roller and the fixing belt 42, when being moved in the semi-separation state by reducing the speed thereof, the abutting force is weak, and the contact time (and being pressed) is short, accordingly, it is possible to reduce the damage and abrasion of the press roller 43.

Hereinafter, the state of the fixing device in each mode will be more specifically described.

In the warm-up mode, the fixing device 37 gets a fixing temperature from starting up of the image forming apparatus 1 by turning on the power. The fixing temperature of the fixing belt 42 is, for example, 170° C. The fixing temperature of the press roller 43 is, for example, 120° C. The nip pressure in the warm-up mode is high. The driving motor 51 causes the press roller 43 to perform a forward rotation in the direction of arrow v shown in FIG. 2, at a speed of 270 mm/sec in the warm-up mode.

In the fixing mode, the temperatures of the fixing belt 42 and the press roller 43 are maintained to 170° C. and 120° C., respectively. The nip pressure in the fixing mode is high to an extent of performing fixing sufficiently in the fixing temperature. The nip pressure in the fixing mode may be set to be the same as, or higher than the nip pressure in the ready mode. The driving motor 51 in the fixing mode causes the press roller 43 to perform the forward rotation at a speed of 270 mm/sec.

On the other hand, in the ready mode, the surface temperature of the fixing belt 42 is maintained to 170° C., and the surface temperature of the press roller 43 is maintained to 120° C. The nip pressure in the ready mode is lower than that in the fixing mode and the warm-up mode. The driving motor 51 in the ready mode causes the fixing belt 42 and the press roller 43 to rotate in the directions of arrows v and t in FIG. 2 at a speed of 90 mm/sec.

In the stand-by mode, the press roller 43 is maintained to a stand-by temperature, for example, at 80° C. The temperature of the fixing belt 42 is decreases gradually because the heating for the fixing belt 42 stops. The image forming apparatus 1 becomes the stand-by mode when a certain time (for example, three minutes) passes in a state of the ready mode. The nip pressure in the preheat mode is lower than that of the warm-up mode. The driving motor 51 in the preheat mode causes the fixing belt 42 and the press roller 43 to rotate in the directions of arrows v and t in FIG. 2 at a speed of 90 mm/sec.

The image forming apparatus 1 becomes the automatic sleep mode when a certain time (for example, thirty minutes) passes in a state of the stand-by mode. The nip pressure in the sleep mode is lower than that of the warm-up mode. The nip pressure in the sleep mode may be the same as that in the stand-by mode. The driving motor 51 in the sleep mode does not cause the press roller 43 to rotate.

Even when it becomes the forcible toner replenishment mode, the image quality maintaining control mode, the low temperature waiting mode, and the high temperature waiting mode, similarly to the ready mode, or the like, the press roller 43 becomes the semi-separation state, and causes the fixing belt 42 to move in the direction of arrow v in the figure at the speed of 90 mm/sec.

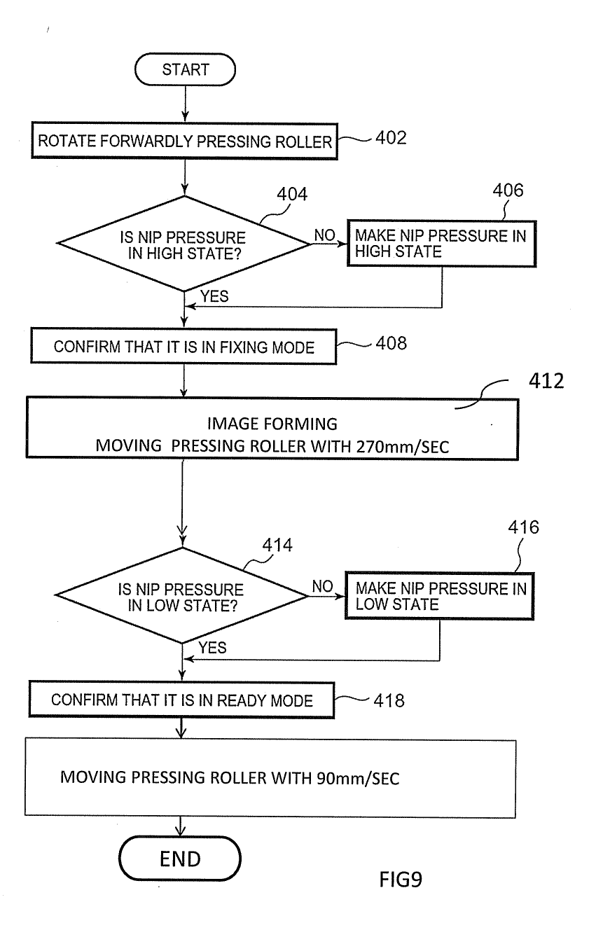

FIG. 9 is a flowchart which shows an operation of the image forming apparatus 1 which transits to the ready mode from the fixing mode after image forming.

The image forming apparatus 1 causes the press roller 43 to perform the forward rotation (act 402)

The image forming apparatus 1 checks whether or not it is the fixing mode. The image forming apparatus 1 checks that the shutter 83 is not blocking the sensor 84 in order to confirm that the nip pressure is in a high state (Yes in act 404).

When the shutter 83 blocks the sensor 84 (No in act 404), in order to make the nip pressure high, the cam 81 and the shutter 83 are rotated by flowing a current to the electromagnetic clutch gear 97 until the shutter 83 does not block the sensor 84, while causing the press roller 43 to perform the forward. rotation (act 406). Then shutter 83 changes its position to block the sensor 84 and go into act 408.

The image forming apparatus 1 recognized that it is the fixing mode (act 408) and performs the image forming operation (act 412), when confirming that the nip pressure is in the high state by forwardly rotating the press roller 43. The image forming apparatus 1 extracts the image bearing medium P from the paper feed cassette 4, or the manual feed unit 31. The image forming apparatus 1 transports the image bearing medium P to the second transfer roller 27 from the resist roller 36 along the transport path 34. The image forming apparatus 1 transports the image bearing medium P on which a toner image is transferred in the second transfer roller 27 to the fixing device 37. The image forming apparatus 1 in the fixing mode causes the fixing belt 42 and the press roller 43 to perform the forward rotation in the direction of the arrow t at the speed of 270 mm/sec (act 412). The nip portion 50 which is formed by the fixing roller 38 and the press roller 43 fixes the toner image onto the image bearing medium P by applying heat and pressure thereto. The image forming apparatus 1 completes the image forming operation by discharging the image bearing medium P on which the toner image is fixed to the paper discharge unit 3.

When completing the image forming operation, the image forming apparatus 1 checks that the shutter 83 is blocking the sensor 84 in order to confirm that the nip pressure is in the low state (act 414). After this confirmation(Yes in act 414), the flow goes into act 418.

When the shutter 83 is not blocking the sensor 84 (No in act 418), in order to make the nip pressure low, the cam 81 and the shutter 83 are rotated by flowing a current to the electromagnetic clutch 97 (act 416). After the shutter 83 blocks the sensor 84, the flow goes into act 418.

The image forming apparatus 1 becomes the ready mode when the shutter 83 blocks the sensor 84 while reversely rotating the press roller 43 (act 418).

In the ready mode, the fixing belt 42 and the press roller 43 move at a speed of 90 mm/sec as a speed of ⅓ of the fixing mode.

While certain embodiments have been described, those embodiments have been presented by way of example only, and are not intended to limit the scope of the inventions. Indeed, the novel methods and apparatuses described herein may be embodied in a variety of other forms; furthermore, various omissions, substitutions and changes in the form of the methods and apparatuses described herein may be made without departing from the spirit of the inventions. The accompanying claims and their equivalents are intended to cover such forms or modifications as would fall within the scope and spirit of the inventions.

What is claimed is:

1. A fixing device comprising:
a fixing member which is heated at predetermined temperature for a fixing;
a press member which is configured to move relative to the fixing member and to contact with the fixing member so as to transport an image bearing medium by cooperating with the fixing member during a fixing;
driving member which moves the fixing member and press member in a plurality of speeds including predetermined speed for during the fixing;
pressure change member which is configured to change a pressure between the fixing member and the press member; and
control member which controls the driving member and the pressure change member, when the fixing member and the press member are idle for fixing, to reduce the pressure and the speed of the fixing member and the press member compared with during the fixing.

2. The fixing device according to claim 1,
wherein the control member reduces the pressure between the fixing member and the press member to less than half of the pressure during the fixing by controlling the pressure change member, and reduces the speed of the fixing member and the press member to less than half speed during the fixing by controlling the driving member.

3. The fixing device according to claim 1,
wherein the controlling member sets the fixing member and the press member at least in a fixing mode in which the fixing is performed and in a ready mode set before and after the fixing mode,
and the control member reduces the pressure between the fixing member and the press member in the ready mode to less than half of the pressure in the fixing mode, and reduces the speed of the fixing member and the press member to less than half speed in the fixing mode.

4. The fixing device according to claim 1,
wherein the fixing member includes a fixing belt.

5. The fixing device according to claim 4,
wherein the fixing member includes an electromagnetic induction-type heater which faces and heats the fixing belt.

6. A method of controlling a fixing device having a fixing member and a press member, the method comprising:
contacting the fixing member and the press member with each other in predetermined pressure for fixing;
moving the fixing member and the press member in a predetermined speed for fixing;
detecting an operation state of the fixing member and the press member; and
reducing the pressure between the fixing member and the press member and the speed of the fixing member and the press member, when the fixing member and the press member are idle for fixing based on the detection result.

7. The method of controlling the fixing device according to claim 6, further comprising:
reducing the pressure between the fixing member and the press member to less than half of the pressure during the fixing and reducing the speed of the fixing member and the press member to less than half speed during the fixing.

8. The method of controlling the fixing device according to claim 6, further comprising:
Reducing, in a ready mode set before and after a fixing mode, the pressure between the fixing member and the press member to less than half of the pressure in the fixing mode,
and the speed of the fixing member and the press member to less than half speed in the fixing mode.

9. The method of controlling the fixing device according to claim 6,
wherein the fixing member includes a fixing belt.

10. The method of controlling the fixing device according to claim 9,
wherein the fixing belt is heated by an electromagnetic induction-type heating body which faces the fixing belt.

11. An image forming apparatus, comprising:
an image forming member which forms a toner image on a image carrier;
a transfer member which transfers the toner image which is formed by the image forming member on a image bearing medium;
a fixing member which is heated at predetermined temperature;
a press member which is configured to move relative to the fixing member and to contact with the fixing member so as to transport an image bearing medium by cooperating with the fixing member during a fixing;
driving member which moves the fixing member and press member in a plurality of speeds including predetermined speed for during the fixing;
pressure change member which is configured to change a pressure between the fixing member and the press member; and
control member which controls the driving member and the pressure change member, when the fixing member and the press member are idle for fixing, to reduce the pressure and the speed of the fixing member and the press member compared with during the fixing.

12. The image forming apparatus according to claim 11,
wherein the control member reduces the pressure between the fixing member and the press member to less than half of the pressure during the fixing by controlling the pressure change member, and reduces the speed of the fixing member and the press member to less than half speed during the fixing by controlling the driving member.

13. The image forming apparatus according to claim 11,
wherein the controlling member sets the fixing member and the press member at least in a fixing mode in which the fixing is performed and in a ready mode set before and after the fixing mode,
and the control member reduces the pressure between the fixing member and the press member in the ready mode to less than half of the pressure in the fixing mode, and reduces the speed of the fixing member and the press member to less than half speed in the fixing mode.

14. The image forming apparatus according to claim 11,
wherein the fixing member includes a fixing belt.

15. The image forming apparatus according to claim 14,
wherein the fixing member includes an electromagnetic induction-type heater which faces and heats the fixing belt.

16. The image forming apparatus according to claim 11,
wherein, in a forcible toner replenishing mode, the control member reduces the pressure between the fixing member and the press member and the speed of the fixing member and the press member compared with during the fixing.

17. The image forming apparatus according to claim 11,
wherein, in a image quality maintaining control mode, the control member reduces the pressure between the fixing member and the press member and reduces the speed of the fixing member and the press member compared with during the fixing.

18. The image forming apparatus according to claim 11,
wherein, in a low temperature waiting mode in which the fixing stops due to dropping of the temperature of the fixing member or of the press member less than a certain threshold value, the control member reduces the pressure between the fixing member and the press member and the speed of the fixing member and the press member compared with during the fixing.

19. The image forming apparatus according to claim 11,
wherein, in a high temperature waiting mode in which the fixing stops due to rising of the temperature of the fixing member or of the press member higher than a certain threshold value, the control member reduces the pressure between the fixing member and the press member and the speed of the fixing member and the press member compared with during the fixing.
